(19) United States
(12) Patent Application Publication
(10) Pub. No.: US 2023/0122707 A1
(43) Pub. Date: Apr. 20, 2023

(54) DISTRIBUTED STORAGE SYSTEM AND METHOD OF STORING LARGE DATA USING BLOCKCHAIN

(71) Applicant: ICONLOOP Inc., Seoul (KR)

(72) Inventor: Moon Kyu Song, Gyeonggi-do (KR)

(21) Appl. No.: 17/966,721

(22) Filed: Oct. 14, 2022

(30) Foreign Application Priority Data
Oct. 20, 2021 (KR) 10-2021-0140407

(51) Int. Cl. H04L 67/1097; H04L 67/06; H04L 9/32

(52) U.S. Cl. CPC H04L 67/1097; H04L 67/06; H04L 9/3236

(57) ABSTRACT

Provided is a distributed storage system for storing large data using a blockchain. The distributed storage system includes a client device configured to generate status data about data status, transmit the status data to a blockchain system, and transmit the data to a storage system, the blockchain system configured to store the status data in a status database, and the storage system configured to store the data received from the client device in a file database or share the data through a network based on the status database.

### CROSS REFERENCE TO RELATED APPLICATION

This application claims the benefit of Korean Patent Application No. 10-2021-0140407, filed on Oct. 20, 2021, in the Korean Intellectual Property Office, the entire disclosure of which is incorporated herein by reference for all purposes.

### BACKGROUND

### 1. Field of the Invention

One or more example embodiments relate to technology of storing large data using a blockchain.

### 2. Description of the Related Art

Big data is used in all industries to apply data to various tasks. Accordingly, companies are making attempts to extract and store various kinds of large data and managing data using various distributed storage systems.

As demand for data storage continues to grow in today's digital world, a distributed storage system is gaining a lot of interest. In a distributed storage system, all or different parts of the data are distributed in a plurality of physically separate computer storage servers (also called storage nodes).

The distributed storage system has many benefits due to distributed storage of data, but also may omit data when hacking occurs or some nodes with data are unavailable.

In contrast, blockchain is also called a public transaction ledger and is technology which prevents hacking which may occur during, representatively, a virtual currency transaction. Conventional financial companies store transaction records in a centralized server, while for blockchain technology, blocks are generated through joint operation of nodes participating in the blockchain network, and the participating nodes verify and approve the generated blocks so that everyone owns the same blocks and data forgery by some nodes is prevented. Blockchain is applied to Bitcoin, the representative online virtual currency. Bitcoin transparently records transaction details in a ledger which is accessible to everyone, and a plurality of nodes using Bitcoin may verify the record to prevent hacking.

### SUMMARY OF THE INVENTION

Example embodiments provide a distributed storage system and a method of storing large data using a blockchain.

According to an aspect, there is provided a distributed storage system for storing large data using a blockchain, the distributed storage system including a client device configured to generate status data about data status, transmit the status data to a blockchain system, and transmit the data to a storage system, the blockchain system configured to store the status data in a status database, and the storage system configured to store the data received from the client device in a file database or share the data through a network based on the status database.

The status database may be configured to store a list of the data and the status data which needs to be shared with the network.

The status database may be configured to operate based on a last status determined by the blockchain and support a setting of a point of restoration to a previous status or a restoration function according to a continuous status change.

The file database may be configured to manage the data, which is determined to be stored, by unit piece, and determine and process a uniformity of data by using a hash function so that the same pieces of data are managed to not be repeatedly stored.

The status data may include a hash value generated for proving each unit piece after dividing the basic information of the data and data into unit pieces.

The blockchain system may be configured to determine a size and a period of the data or access information of the data which need to be stored through the status data without a transmission of any actual data.

The blockchain system may be configured to receive the status data, the client device may be configured to store the data in a node through the storage system when storage is determined through agreement, and the stored data may be accessible.

According to another aspect, there is provided a method of storing large data in a distributed storage system using a blockchain, the method including generating, by a client device, status data about data status, transmitting the status data to a blockchain system and transmitting the data to a storage system, storing, by the blockchain system, the status data in a status database, and storing, by the storage system, the data received from the client device in a file database or sharing the data through a network based on the status database.

The status database may be configured to store a list of the data and the status data which needs to be shared with the network.

The status database may be configured to operate based on a last status determined by the blockchain and support a setting of a point of restoration to a previous status or a restoration function according to a continuous status change.

The file database may be configured to manage the data, which is determined to be stored, by unit piece, and determine and process a uniformity of data by using a hash function so that the same pieces of data are managed to not be repeatedly stored.

The status data may include a hash value generated for proving each unit piece after dividing the basic information of the data and data into unit pieces.

The blockchain system may be configured to determine a size and a period of the data or access information of the data which need to be stored through the status data without a transmission of any actual data.

The blockchain system may be configured to receive the status data, the client device may be configured to store the data in a node through the storage system when storage is determined through agreement, and the stored data may be accessible.

Additional aspects of example embodiments will be set forth in part in the description which follows and, in part, will be apparent from the description, or may be learned by practice of the disclosure.

According to example embodiments, example embodiments relate to a distributed storage system and a method of storing large data using a blockchain. Since the blockchain stores status data about data status, not the data, the size of the data, which has to be transmitted for agreement, and associated transactions may be reduced. Also, the blockchain may calculate necessary costs, easily prevent contamination of stored data, and clearly show any repetitions in the stored data.

Also, according to example embodiments, even if data stored in the network is temporarily lost due to an accident, the distributed storage system of the present disclosure may restore the data into a sharable state if there is data stored in a server or a location.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a distributed storage system for storing large data using a blockchain, according to an example embodiment; and

FIG. 2 is a flowchart illustrating a process of storing large data by a distributed storage system using a blockchain, according to an example embodiment.

### DETAILED DESCRIPTION

Hereinafter, example embodiments will be described in detail with reference to the accompanying drawings. However, various alterations and modifications may be made to the example embodiments. Here, the example embodiments are not meant to be limited by the descriptions of the present disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of the example embodiments, a detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions of the example embodiments may be applicable to the following example embodiments and thus, duplicated descriptions will be omitted for conciseness.

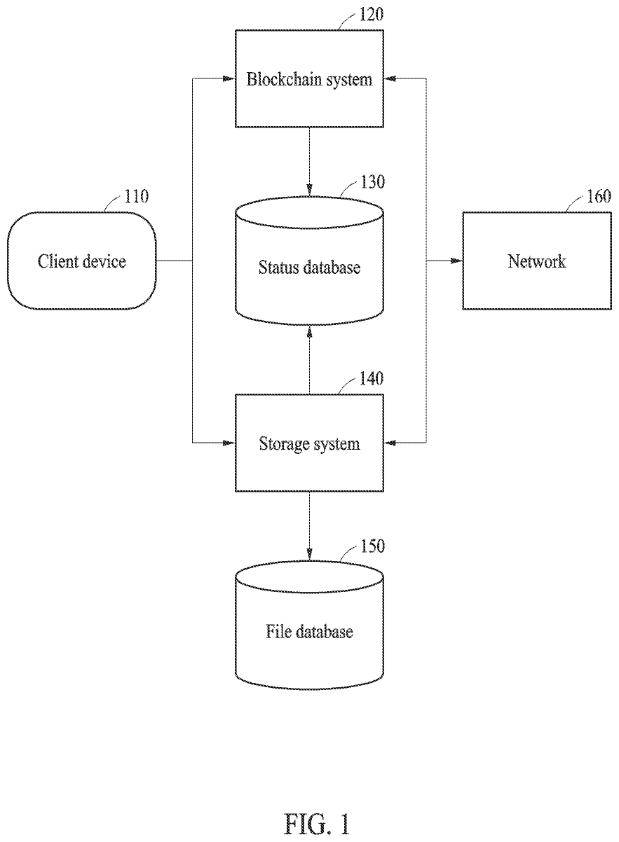

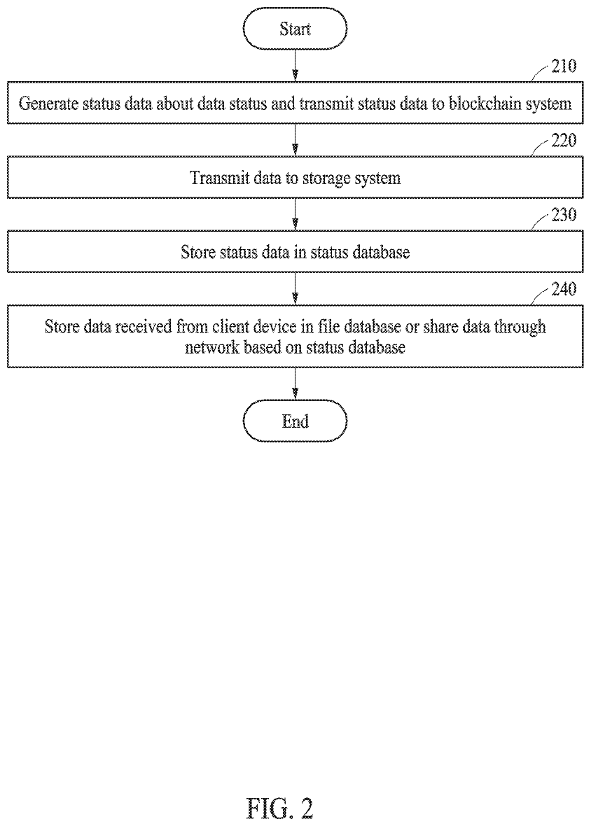

Hereinafter, a distributed storage system and a method of storing large data using a blockchain, according to an example embodiment of the present disclosure, will be described in detail with reference to the accompanying FIGS. 1 and 2.

FIG. 1 is a diagram illustrating a configuration of a distributed storage system for storing large data using a blockchain, according to an example embodiment.

Referring to FIG. 1, the distributed storage system of the present disclosure may include a client device 110, a blockchain system 120, a status database 130, a storage system 140, a file database 150, and a network 160.

The client device 110 may generate status data about data status, transmit the status data to the blockchain system 120, and transmit the data to the storage system 140. Here, the status data may include a hash value generated for proving each unit piece after dividing the basic information of the data and data into unit pieces.

The blockchain system 120 may store the status data in the status database 130.

Here, the blockchain system 120 may determine the size and period of the data which needs to be stored through the status data, or may access information of the data without transmission of any actual data.

Also, the blockchain system 120 may be configured to receive the status data, the client device 110 may be configured to store the data in a node through the storage system 140 when storage is determined through agreement, and the stored data may be accessible.

The status database 130 may store a list of data and the status data which needs to be shared with a network.

The status database 130 may be configured to operate based on a last status determined by the blockchain and support a setting of a point of restoration to a previous status or a restoration function according to a continuous status change.

The storage system 140 may store the data received from the client device 110 in the file database 150 or share the data through the network 160 based on the status database 130.

The file database 150 may manage the data, which is determined to be stored, by unit piece, and determine and process a uniformity of data by using a hash function so that the same pieces of data are managed to not be repeatedly stored.

Hereinafter, a method according to the present disclosure configured as described above will be described with reference to the drawings.

FIG. 2 is a flowchart illustrating a process of storing large data by a distributed storage system using a blockchain, according to an example embodiment.

Referring to FIG. 2, the client device 110 of the distributed storage system may generate and transmit status data about data status to the blockchain system 120 in operation 210. Here, the status data may include a hash value generated for proving each unit piece after dividing the basic information of the data and data into unit pieces.

Also, the client device 110 of the distributed storage system may transmit the data to the storage system 140 in operation 220.

The blockchain system 120 of the distributed storage system may store the status data in the status database 130 in operation 230.

Here, the status database 130 may store a list of data and the status data which needs to be shared with a network. In addition, the status database 130 may be configured to operate based on a last status determined by the blockchain and support a setting of a point of restoration to a previous status or a restoration function according to a continuous status change.

The blockchain system 120 may determine the size and period of the data which needs to be stored through the status data, or access information of the data without transmission of any actual data.

The blockchain system 120 may be configured to receive the status data, the client device 110 may be configured to store the data in a node through the storage system 140 when storage is determined through agreement, and the stored data may be accessible.

The storage system 140 of the distributed storage system may store the data received from the client device 110 in the file database 150 or share the data through a network based on the status database 130 in operation 210.

The file database 150 may manage the data, which is determined to be stored, by unit piece, and determine and process a uniformity of data by using a hash function so that the same pieces of data are managed to not be repeatedly stored.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media may include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions may include both machine code, such as produced by a compiler, and files including higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, other implementations, other example embodiments, and equivalents to the claims are also within the scope of the following claims.

What is claimed is:

1. A distributed storage system for storing large data using a blockchain, the distributed storage system comprising:
a client device configured to generate status data about data status, transmit the status data to a blockchain system, and transmit the data to a storage system;
the blockchain system configured to store the status data in a status database; and
the storage system configured to store the data received from the client device in a file database or share the data through a network based on the status database.

2. The distributed storage system of claim 1, wherein the status database is configured to store a list of the data and the status data which needs to be shared with the network.

3. The distributed storage system of claim 1, wherein the status database is configured to operate based on a last status determined by the blockchain and support a setting of a point of restoration to a previous status or a restoration function according to a continuous status change.

4. The distributed storage system of claim 1, wherein the file database is configured to manage the data, which is determined to be stored, by unit piece, and determine and process a uniformity of data by using a hash function so that the same pieces of data are managed to not be repeatedly stored.

5. The distributed storage system of claim 1, wherein the status data comprises a hash value generated for proving each unit piece after dividing the basic information of the data and data into unit pieces.

6. The distributed storage system of claim 1, wherein the blockchain system is configured to determine a size and a period of the data or access information of the data which need to be stored through the status data without a transmission of any actual data.

7. The distributed storage system of claim 1, wherein
the blockchain system is configured to receive the status data,
the client device is configured to store the data in a node through the storage system when storage is determined through agreement, and
the stored data is accessible.

8. A method of storing large data in a distributed storage system using a blockchain, the method comprising:
generating, by a client device, status data about data status, transmitting the status data to a blockchain system and transmitting the data to a storage system;
storing, by the blockchain system, the status data in a status database; and
storing, by the storage system, the data received from the client device in a file database or sharing the data through a network based on the status database.

9. The method of claim 8, wherein the status database is configured to store a list of the data and the status data which needs to be shared with the network.

10. The method of claim 8, wherein the status database is configured to operate based on a last status determined by the blockchain and support a setting of a point of restoration to a previous status or a restoration function according to a continuous status change.

11. The method of claim 8, wherein the file database is configured to manage the data, which is determined to be stored, by unit piece, and determine and process a uniformity of data by using a hash function so that the same pieces of data are managed to not be repeatedly stored.

12. The method of claim 8, wherein the status data comprises a hash value generated for proving each unit piece after dividing the basic information of the data and data into unit pieces.

13. The method of claim 8, wherein the blockchain system is configured to determine a size and a period of the data or access information of the data which need to be stored through the status data without a transmission of any actual data.

14. The method of claim 8, wherein
the blockchain system is configured to receive the status data,
the client device is configured to store the data in a node through the storage system when storage is determined through agreement, and
the stored data is accessible.

15. A non-transitory computer-readable storage medium storing instructions that, when executed by a processor, cause the processor to perform:
generating, by a client device, status data about data status, transmitting the status data to a blockchain system and transmitting the data to a storage system;
storing, by the blockchain system, the status data in a status database; and
storing, by the storage system, the data received from the client device in a file database or sharing the data through a network based on the status database.

16. The non-transitory computer-readable storage medium of claim 15, wherein the status database is configured to store a list of the data and the status data which needs to be shared with the network.

17. The non-transitory computer-readable storage medium of claim 15, wherein the status database is configured to operate based on a last status determined by the blockchain and support a setting of a point of restoration to a previous status or a restoration function according to a continuous status change.

18. The non-transitory computer-readable storage medium of claim 15, wherein the file database is configured to manage the data, which is determined to be stored, by unit piece, and determine and process a uniformity of data by using a hash function so that the same pieces of data are managed to not be repeatedly stored.

19. The non-transitory computer-readable storage medium of claim 15, wherein the status data comprises a hash value generated for proving each unit piece after dividing the basic information of the data and data into unit pieces.

20. The non-transitory computer-readable storage medium of claim 15, wherein the blockchain system is configured to determine a size and a period of the data or access information of the data which need to be stored through the status data without a transmission of any actual data.
